(19) United States
(12) Patent Application Publication
(10) Pub. No.: US 2026/0104597 A1
(43) Pub. Date: Apr. 16, 2026

(54) MODULAR EYEWEAR

(71) Applicant: Robert James Stutelberg, Hastings, MN (US)

(72) Inventor: Robert James Stutelberg, Hastings, MN (US)

(21) Appl. No.: 19/420,674

(22) Filed: Dec. 15, 2025

Related U.S. Application Data
(63) Continuation-in-part of application No. 18/181,323, filed on Mar. 9, 2023, now abandoned.

(51) Int. Cl. G02C 5/22; G02C 5/14

(52) U.S. Cl. CPC G02C 5/22; G02C 5/14

(57) ABSTRACT

A modular eyewear device configured to convert between a first state exhibiting a first appearance and a second state exhibiting a second appearance. A specialized pivoting hinge is disposed on both temples of the eyewear, enabling a user to effectively invert the eyewear by pivoting each arm 180-degrees forward or backward to switch between the first state and second state. Each side of each arm exhibits a different color, texture, pattern, or design. A front of the eyewear, configured to conventionally contain lenses, is also equipped with a first design state on one side and a second design state on the second side. Individual first and second lens frames, assembled to flip on nosepiece axis, are independently movable so as to convert between a first state and second state.

### CONTINUITY

This application is a Continuation-in-Part application of non-provisional patent application Ser. No. 18/181,323 filed on Mar. 9, 2023, and priority is claimed thereto.

### FIELD OF THE PRESENT INVENTION

The present invention relates to the field of optometry and cosmetic eyewear, and more specifically relates to a new form of eyeglasses and/or sunglasses frames configured to easily and quickly convert its outward appearance from a first set of colors to a second set of colors without removal or replacement of any component of the eyewear.

### BACKGROUND OF THE PRESENT INVENTION

Conventional eyewear, traditionally equipped with frames and lenses, have been around for centuries, which are generally configured to aid the vision of the wearer. In recent years, eyewear has evolved into a form of fashion, with countless manufacturers producing eyeglasses and sunglasses in a wide variety of shapes, colors, and sizes. Some individuals have even started to wear eyeglasses without lenses, or with lenses that are not tailored to a specific prescription just for the fashion statement inherent in wearing such aesthetically pleasing eyewear.

However, traditional eyewear is generally restricted to a static appearance. As such, only a single color, texture, or pattern is generally available for the entirety of the frames. While some modular forms of eyewear exist on the market, they all require the complete removal of components of the frames in order to facilitate customization of the appearance of the eyewear on-the-go. If there were a way to easily alter the appearance of eyewear without the need to replace components of the eyewear, users could change the colors of their eyewear quickly to match outfits or to match the mood of the user at will.

Thus, there is a need for a new form of modular eyewear configured to easily transform from a first outward appearance to a second (or third) outward appearance. Such an apparatus is preferably configured to invert between a first state and a second state, with each state exhibiting a different color, texture, shape(s) and/or patterns to enable the user to quickly switch between multiple designs/colors without the need to remove/replace components of the eyewear.

### SUMMARY OF THE INVENTION

The present invention is a modular eyewear apparatus configured to facilitate an inversion of the frames, arms and glasses body to provide for two or more states of presentation. As such, the present invention is configured for parts and the whole to convert between a first state and a second state easily and without tools. A spring-based, 180-degree pivoting joint is disposed on each temple of the eyewear, which facilitate the conversion of the eyewear between the first state and the second state. There is a first arm and a second arm, each having a first color disposed on a first side, and a second color disposed on a second side. The pivoting joint is a special type of hinge configured to enable the conversion of the eyewear from the first state to the second state. A nosepiece of the eyewear is preferably symmetrical on both the X and Y axis so that the framepiece may be worn on the face in either the first state or the second state with equal comfort.

Alternately, the nosepiece has a first color disposed on a first side, and a second color disposed on a second side. The nosepiece is situated with a wire running through its center, allowing positional rotation so the wearer may choose which side to display. A pin axis at each arm connects to two lens-holding frames. Two lens frames are configured to flip on the nosepiece and arm axes so a wearer may position each lens frame as desired.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention, shown in a first state, as seen from the front and side.

FIG. 2 depicts a view of the apparatus of the present invention, shown in a second state, as seen from the front and side.

FIG. 3 shows a view of the apparatus of the present invention, shown in the middle of the conversion between the first state and the second state, as seen from above.

FIG. 4 exhibits a flow chart detailing the process of use of the apparatus of the present invention by an end user.

FIG. 5 depicts an exploded diagram of a hinge assembly of the apparatus of the present invention as shown from the side.

FIG. 6 depicts an alternative version of the invention in which the nosepiece and the two lens-holding frames can each be flipped by a wearer to change from a first state to a second state.

FIG. 7 exhibits a flow chart detailing the use of the alternate version of the present invention.

### DETAILED DESCRIPTION OF THE PRESENT INVENTION

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is a modular eyewear apparatus configured to provide additional fashionable options to a wearer of the eyewear via a simple aesthetic transformation. The present invention is equipped with lenses (10) and a framepiece (20). The framepiece (20) is equipped with arms (30) which are conventionally disposed on sides of the framepiece (20). 180-degree hinges (40) are present on the sides of the framepiece (20), at the temple, disposed in communication with the arms (30). The 180-degree hinges (40) are equipped with at least one spring (50) to provide tension to the arms (30), helping them to remain in one of two positions, with the 180-degree hinges (40) at a “zero” degree position or with the 180-degree hinges (40) at a 180-degree position. In further embodiments of the present invention, the apparatus is equipped with 360-degree hinges, which facilitate the folding of the eyewear into a closed position, as well as conversion between two design states. In all embodiments, the hinges are preferably configured to ‘click’ or have a conventional friction-based locking mechanism present to maintain the arms (30) in a desired position. For embodiments equipped with 180-degree hinges (40), there are preferably two desired positions into which the hinges (40) may lock. For embodiments equipped with 360-degree hinges, there are preferably four positions into which the hinges may lock.

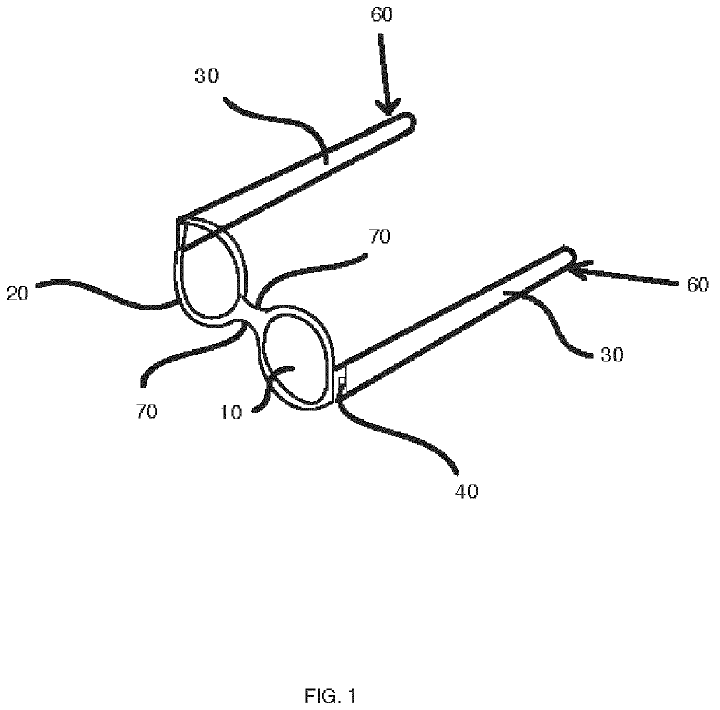

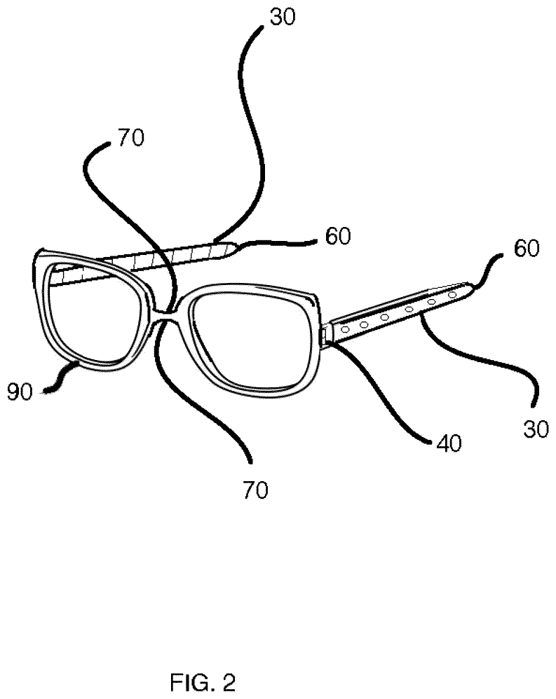

The 180-degree hinges (40) facilitate the conversion of the apparatus between a first state, as depicted in FIG. 1, exhibiting a first design, and a second state, shown in FIG. 2, exhibiting a second design. Each design is envisioned to be unique from the other, portraying textures, patterns, shapes, logos, text, colors, and other design elements that greatly differ.

The arms (30) are equipped with ends (60) disposed opposite of the connection of the arms (30) to the 180-degree hinges (40). The ends (60) of the arms (30) are preferably straight, however in some embodiments of the present invention, the ends (60) may taper down such that they may partially hook over ears of the user in either the first state or second state.

A nosepiece (70) of the framepiece (20) is preferably designed such that it is comfortable and fashionable when viewed in both the first state and the second state. As such, the nosepiece (70) is preferably symmetrical, mirroring itself from the front and back of the front of the framepiece (20) to ensure that the apparatus may be comfortably worn in either the first state or the second state. Due to the reversable nature of the present invention, it should be noted that the lenses (10) are preferably non-prescription lenses and/or sunglasses. In other embodiments, the lenses (10) themselves may be removed and reversed within the framepiece (20) to enable use of prescription lenses.

As depicted in FIG. 1, the arms (30) are preferably wider than the arms found on conventional or traditional eyewear so as to more easily show the design elements present on the arms (30). Further, it should be understood that a front (80) of the framepiece (20) is preferably equipped with a design which differs from a rear (90) of the framepiece (20) such that the entirety of the outward appearance of the present invention changes when switching between the first state and the second state. Similarly, the framepiece (20) itself need not be inherently symmetrical, as with traditional glasses, but the specially designed nosepiece (70) may still facilitate inversion of the glasses to be worn “upside down” to further provide different ways of wearing the present invention, and therefore exhibiting different styles as shown in FIG. 2.

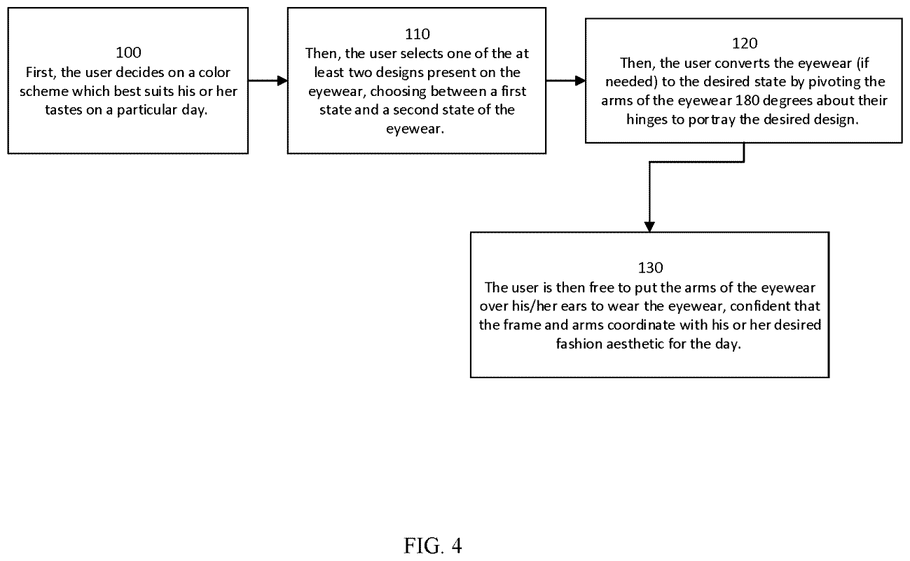

The process of use of the apparatus of the present invention, as shown in FIG. 4, is preferably as follows:
1. First, the user decides on a color scheme which best suits his or her tastes on a particular day. (100) The color scheme may match or contrast with other elements of his/her aesthetic.
2. Then, the user selects one of the at least two designs present on the eyewear, choosing between a first state and a second state of the eyewear. (110)
3. Then, the user converts the eyewear (if needed) to the desired state by pivoting the arms of the eyewear 180 degrees about their hinges to portray the desired design. (120)
4. The user is then free to put the arms of the eyewear over his/her ears to wear the eyewear, confident that the framepiece and arms coordinate with his or her desired fashion aesthetic for the day. (130)

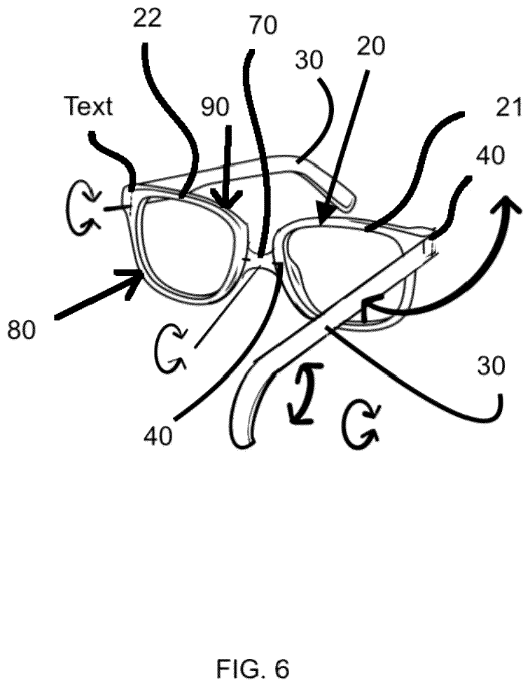

FIG. 6 depicts an alternate embodiment of the present invention. In such an embodiment, each lens frame (21), (22) and the nosepiece (70) can independently flip from a first side to a second side, allowing wearer to wear the present invention in various combinations of orientations.

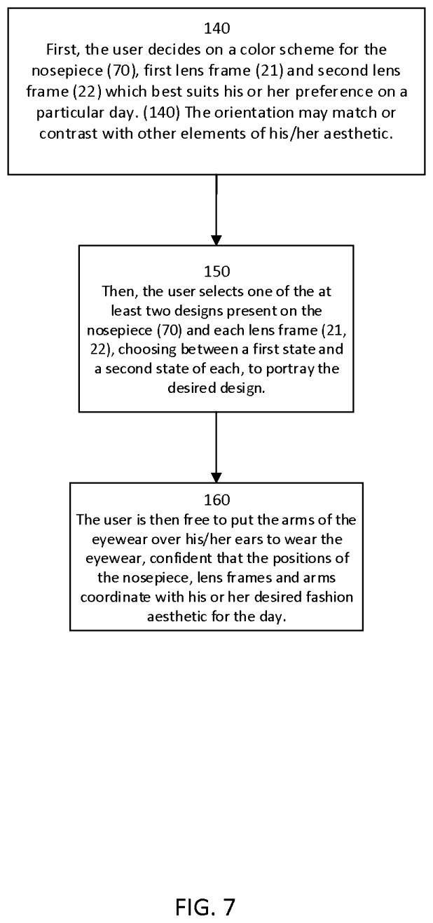

The process of use of the alternate embodiment of the present invention, as shown in FIG. 7, is preferably outlined and assembled as follows:
1. First, the user decides on a color scheme for the nosepiece (70), first lens frame (21) and second lens frame (22) which best suits his or her preference on a particular day. (140) The orientation may match or contrast with other elements of his/her aesthetic.
2. Then, the user selects one of the at least two designs present on the nosepiece (70) and each lens frame (21, 22), choosing between a first state and a second state of each, to portray the desired design. (150)
3. The user is then free to put the arms of the eyewear over his/her ears to wear the eyewear, confident that the positions of the nosepiece, lens frames and arms coordinate with his or her desired fashion aesthetic for the day. (160)

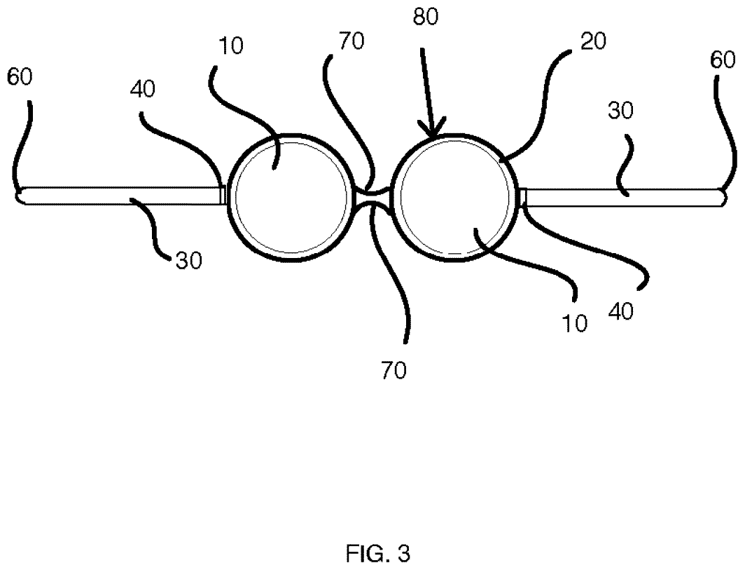

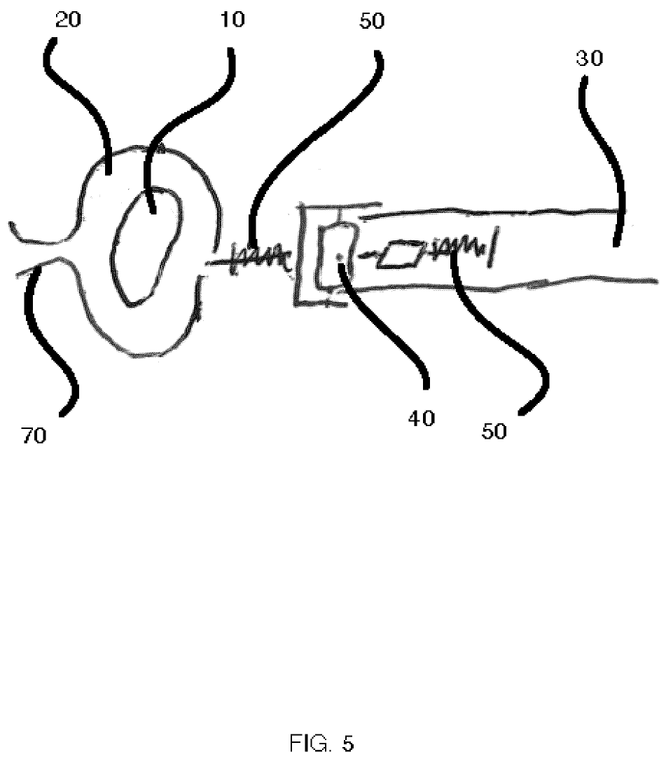

A second alternative embodiment of the present invention combines the features of FIGS. 1-5 with those of FIGS. 6 and 7, where the arms (30) are preferably wider than the arms found on conventional or traditional eyewear to more easily show the design elements present on the arms (30).

The framepiece (20) has two lens frames (21), (22) and a nosepiece (70) each preferably equipped with a front (80) design which differs from a rear (90) design such that the entirety of the outward appearance of the present invention changes when switching between the first state and the second state of any of the aforementioned parts.

It should be understood that the 180-degree hinges (40) are configured to enable the user to wear the glasses in a total of four different ways. This is due in part, in some embodiments of the present invention, to the both vertically and horizontally symmetrical nosepiece (70) and predominantly straight arms (30). Not only may the arms (30) be inverted by folding them outwards 180 degrees via the 180-degree hinges (40), but the framepiece itself can be flipped over if desired due to the symmetrical nosepiece which enables the wearer to wear the present invention in either orientation. Further, the arms (30) (first arm and second arm) may mirror each other in preferred embodiments such that they match even when inverted.

It should be understood that the present invention is a modular eyewear apparatus which has a first 180-degree hinge, a second 180-degree hinge, a first axis pin, a second axis pin, a third axis pin, a first arm disposed in communication with the first 180-degree hinge and first axis pin, a second arm disposed in communication with the second 180-degree hinge and second axis pin, a first lens frame, the first lens frame disposed in communication with the first 180-degree hinge and the first axis pin, a second lens frame, the second lens frame disposed in communication with said second 180-degree hinge and said second axis pin, and a nosepiece disposed centrally between the lens frames in communication with the third axis pin. Further, the first arm and second arm may be planar and straight, however some embodiments may depict slight curvature near the ends of the arms. The nosepiece is horizontally symmetrical so that the eyewear is still comfortable to wear when inverted. Further, it should be understood that the design and/or coloration of a front of the arms differ from that of the back of the arms. Similarly, the lens frames exhibit different colorations on the front and back. Finally, the nosepiece exhibits differing designs or colorations on the front and back as well.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An eyeglass apparatus comprising:
a first 180-degree hinge;
a second 180-degree hinge;
a first arm, said first arm disposed in communication with said first 180-degree hinge;
a second arm, said second arm disposed in communication with said second 180-degree hinge;
a framepiece, said framepiece disposed in communication with said first 180-degree hinge and said second 180-degree hinge;
a nosepiece, said nosepiece disposed centrally on said framepiece;
wherein said first arm and said second arm are planar and straight.

2. The apparatus of claim 1, wherein said nosepiece is horizontally symmetrical such that said framepiece may be inverted and still be worn.

3. The apparatus of claim 1, wherein said first arm has a front side and a rear side, with said front side exhibiting a different appearance than said rear side.

4. The apparatus of claim 1, wherein said second arm has a front side and a rear side, with said front side exhibiting a different appearance than said rear side.

5. The apparatus of claim 1, wherein said framepiece has a front side and a rear side, with said front side exhibiting a different appearance than said rear side.

6. The apparatus of claim 1, wherein said first arm mirrors said second arm.

7. The apparatus of claim 2, wherein said first arm has a front side and a rear side, with said front side exhibiting a different appearance than said rear side.

8. The apparatus of claim 2, wherein said second arm has a front side and a rear side, with said front side exhibiting a different appearance than said rear side.

9. The apparatus of claim 2, wherein said framepiece has a front side and a rear side, with said front side exhibiting a different appearance than said rear side.

10. The apparatus of claim 2, wherein said first arm mirrors said second arm.

11. The apparatus of claim 3, wherein said second arm has a front side and a rear side, with said front side exhibiting a different appearance than said rear side.

12. The apparatus of claim 3, wherein said framepiece has a front side and a rear side, with said front side exhibiting a different appearance than said rear side.

13. The apparatus of claim 3, wherein said first arm mirrors said second arm.

14. The apparatus of claim 7, wherein said second arm has a front side and a rear side, with said front side exhibiting a different appearance than said rear side.

15. The apparatus of claim 7, wherein said framepiece has a front side and a rear side, with said front side exhibiting a different appearance than said rear side.

16. An eyeglass apparatus comprising:
a first 180-degree hinge;
a second 180-degree hinge;
a first axis pin;
a second axis pin;
a third axis pin;
a first arm, said first arm disposed in communication with said first 180-degree hinge and first axis pin;
a second arm, said second arm disposed in communication with said second 180-degree hinge and second axis pin;
a first lens frame, said frame disposed in communication with said first 180-degree hinge and said first axis pin;
a second lens frame, said frame disposed in communication with said second 180-degree hinge and said second axis pin;
a nosepiece, said nosepiece disposed centrally between said first lens frame and said second lens frame in communication with said third axis pin;
wherein said first arm and said second arm are planar and straight;
wherein said nosepiece is horizontally symmetrical such that said lens frames may be inverted and still be worn;
wherein said first arm has a front side and a rear side, with said front side exhibiting a different appearance than said rear side;
wherein said second arm has a front side and a rear side, with said front side exhibiting a different appearance than said rear side;
wherein said framepiece has a front side and a rear side, with said front side exhibiting a different appearance than said rear side; and
wherein said first arm mirrors said second arm.
